(19) United States
(12) Patent Application Publication
(10) Pub. No.: US 2014/0041548 A1
(43) Pub. Date: Feb. 13, 2014

(54) PROCESS FOR PRODUCING SIO2 MOULDINGS

(71) Applicants: Jürgen Erwin Lang, Karlsruhe (DE); Maciej Olek, Kahl (DE); Hartwig Rauleder, Rheinfelden (DE); Bodo Frings, Schloss Holte (DE); Rüdiger Schütte, Alzenau-Horstein (DE); Georg Borchers, Bad Nauheim (DE); Georg Markowz, Alzenau (DE); Florian Zschunke, Frankfurt am Main (DE)

(72) Inventors: Jürgen Erwin Lang, Karlsruhe (DE); Maciej Olek, Kahl (DE); Hartwig Rauleder, Rheinfelden (DE); Bodo Frings, Schloss Holte (DE); Rüdiger Schütte, Alzenau-Horstein (DE); Georg Borchers, Bad Nauheim (DE); Georg Markowz, Alzenau (DE); Florian Zschunke, Frankfurt am Main (DE)

(73) Assignee: EVONIK DEGUSSA GMBH, Essen (DE)

(21) Appl. No.: 14/001,644

(22) PCT Filed: Feb. 14, 2012
(86) PCT No.: PCT/EP2012/052441

§ 371 Date: Oct. 23, 2013

(30) Foreign Application Priority Data
Feb. 25, 2011 (DE) 102011004748.4
Mar. 30, 2011 (DE) 102011006406.0

(51) Int. Cl. C04B 35/626; C04B 35/14

(52) U.S. Cl. CPC C04B 35/62625; C04B 35/14
USPC 106/286.8; 423/335; 106/287.1; 106/287.34

(57) ABSTRACT

The present invention relates to a process for producing SiO₂ mouldings, comprising the preparation of a free-flowing aqueous SiO₂ composition, solidification of the aqueous SiO₂ composition and drying of the solidified SiO₂ composition, wherein the aqueous SiO₂ composition is a self-assembly composition.

The present invention further relates to a moulding obtainable by the process according to the invention.

The invention relates to processes for producing SiO₂ mouldings. The present invention further relates to SiO₂ mouldings obtainable by this process.

A significant cost factor in the production of electronic components, especially of photovoltaic cells, is the expenditure for the high-purity silicon needed for this purpose. Accordingly, great efforts have already been made to obtain silicon with the required purity inexpensively. One relatively inexpensive process is detailed in WO 2010/037694. In this process, SiO₂ is reduced by carbon in a light arc furnace to give metallic silicon. The starting material used is typically an SiO₂ moulding in combination with a carbon source.

For this purpose, SiO₂ can be purified by a washing process. The purified SiO₂ is typically ground, then admixed with a carbon source, for example a carbohydrate, and compacted to a moulding. The carbohydrate present in the moulding can subsequently be pyrolysed to carbon in order to obtain a moulding which can be reduced to silicon in a light arc furnace.

In addition, SiO₂ mouldings are in many cases used for production of crucibles in which metallic silicon is purified by directional solidification. The production of these high-purity mouldings at present requires a very high level of complexity.

The processes known from the prior art for production of high-purity silicon already exhibit a good profile of properties. However, there is a constant need to improve these processes. Especially the production of high-purity SiO₂ mouldings as one aspect of the object detailed above constitutes a challenge.

In view of the prior art, it was thus an object of the present invention to provide a process for producing SiO₂ mouldings, which can be performed in a simple and inexpensive manner.

One object was, more particularly, that of providing high-purity SiO₂ mouldings in a desired shape without having to use a particularly large amount of energy for this purpose. Moreover, the purity of the SiO₂ mouldings was not to be impaired by the process measures. Furthermore, the process for producing the high-purity SiO₂ moulding was to be performable with a minimum energy requirement.

In addition, the process was to be performable with a minimum number of process steps, and these were to be simple and reproducible. For instance, the process was to be performable continuously at least in part. Moreover, in the production of an SiO₂ moulding which can be used in combination with a carbon source to obtain metallic silicon, good and homogeneous contact of the carbon source with the silicon dioxide was to be achievable.

Furthermore, the performance of the process was not to be associated with any danger to the environment or to human health, and so it was to be possible to essentially dispense with the use of substances or compounds harmful to health, which could be associated with disadvantages for the environment.

It was a further object of the present invention to provide an SiO₂ moulding which can be used especially for production of high-purity metallic silicon.

In addition, the process was to be implementable without the construction of new and complex plants for performance of the process for producing the SiO₂ moulding.

Furthermore, the feedstocks used were to be preparable or obtainable very inexpensively.

The need for development with regard to these aspects is described in more detail hereinafter in the description of the disadvantages of the prior art and of the object of this invention derived therefrom.

These objects, and further objects which are not stated explicitly but can be derived in an obvious manner from the connections discussed herein or are the inevitable result thereof, are achieved by the process described in claim 1. Appropriate modifications to this process are protected in the dependent claims which refer back to Claim 1.

The present invention accordingly provides a process for producing SiO₂ mouldings, comprising the preparation of an aqueous SiO₂ composition, solidification of the aqueous SiO₂ composition and drying of the solidified SiO₂ composition, which is characterized in that the aqueous SiO₂ composition is a self-assembly composition.

The process according to the invention can be performed in a simple and inexpensive manner. More particularly, no new plants of complex construction are required to perform the process. Furthermore, the energy requirement for production of the SiO₂ moulding can be reduced by the process according to the invention.

Furthermore, the process according to the invention enables the production of high-purity SiO₂ mouldings in any desired shape without any need for a particularly large amount of energy for this purpose. Thus, the process can be performed continuously. Furthermore, many process steps can be performed in an automated manner.

Moreover, the purity of the SiO₂ moulding is not impaired by the process measures. It is surprisingly possible, more particularly, to dispense with the addition of significant amounts of binders. Furthermore, the mouldings exhibit a high stability without any need to use binders.

By means of the process, it is possible to obtain a moulding without the devolatilization of the composition which is normally required in the course of compaction. Accordingly, many advantages which arise especially from the high level of complexity needed for production of SiO₂ mouldings by compaction according to the prior art processes are achieved. Relatively high capital costs are also needed for compaction. Furthermore, compaction plants require a high level of maintenance. Moreover, these plants can lead to contamination in the SiO₂ mouldings.

In addition, the process can be performed with relatively few process steps, and these are simple and reproducible. Moreover, the production of an SiO₂ moulding which can be used in combination with a carbon source to obtain metallic silicon achieves good and homogeneous contact of the carbon source with the silicon dioxide.

Furthermore, the performance of the process is not associated with any danger to the environment or to human health, and so it is possible to essentially dispense with the use of substances or compounds harmful to health, which could be associated with disadvantages for the environment.

Furthermore, the feedstocks used are generally preparable or obtainable inexpensively.

The present process serves for production of SiO₂ mouldings. SiO₂ mouldings in the context of the present invention are articles having a high proportion of silicon dioxide. More particularly, preferred SiO₂ mouldings can be used as a raw material for production of metallic silicon. Furthermore, SiO₂ mouldings can advantageously be used for production of components which find use in connection with the production and further processing of metallic silicon and are familiar to those skilled in the art.

The term “SiO₂ composition” refers to a composition which comprises SiO₂ with different proportions of free and/or bound water, though the degree of condensation of the silicon dioxide is not important per se for this composition. Accordingly the term “SiO₂ composition” also includes compounds with SiOH groups which can typically also be referred to as polysilicic acids.

An aqueous SiO₂ composition usable for the process according to the invention is a self-assembly composition. The term “self-assembly” indicates that an aqueous SiO₂ composition suitable for the present process can be converted reversibly from a solidified to a free-flowing state. At the same time, preferably no lasting phase separation takes place to any great degree, such that the water in a macroscopic assessment is distributed essentially homogeneously in the SiO₂ phase. However, it should be emphasized in this context that two phases are of course present in a microscopic view. A free-flowing state means in the context of the present invention that the aqueous SiO₂ composition has a viscosity of preferably at most 30 Pas, more preferably at most 20 Pas and especially preferably at most 7 Pas, measured immediately after production of the composition (approx. 2 minutes after sampling), with a rotary rheometer at approx. 23° C., which is operated at a shear rate between 1 and 200 [1/s]. At a shear rate of 10 [1/s], the introduction is effected over a period of approx. 3 minutes. The viscosity is then about 5 Pas, determined with a Rheostress viscometer from Thermo Haake using the vane rotor 22 (diameter 22 mm, 5 blades) with a measurement range of 1 to 2.2 10⁶ Pas. At a shear rate of 1 [1/s] and otherwise the same settings, a viscosity of 25 Pas is measured.

The aqueous SiO₂ composition is in a solidified state at a startup viscosity of preferably at least 30 Pas, more preferably at least 100 Pas. This value is determined using the viscosity value of the rheometer 1 second after the vane rotor of the rotary rheometer has started up at approx. 23° C. and a shear rate of 10 [1/s].

Preferably, a solidified aqueous SiO₂ composition can be liquefied again by the action of shear forces for shaping. For this purpose, it is possible to use customary processes and apparatuses familiar to those skilled in the art, for example mixers, stirrer units or mills with a suitable tool geometry for introduction of shear forces. The preferred apparatuses include intensive mixers (Eirich), continuous mixers or annular bed mixers, for example from Lödige; stirred vessels with mixing units preferably having a pitched blade or a toothed disc; but also mills, especially colloid mills or other rotor-stator systems which use annular gaps of different width and different speed. Additionally suitable are ultrasound-based apparatuses and tools, especially sonotrodes and preferably ultrasound sources which have a curved exciter, which allows shear forces to be introduced in the SiO₂-water composition in a particularly simple and defined manner, which leads to the liquefaction thereof. It is particularly advantageous that no particular abrasion is effected by a tool here. This ultrasound arrangement is preferably operated in the nonlinear range. The apparatus used for liquefaction of the aqueous SiO₂ composition in this aspect of the invention is generally dependent on the shear force required for liquefaction. Surprising advantages can be achieved, inter alia, by means of an apparatus whose shear rate (reported as the peripheral speed of the tool) is in the range from 0.01 to 50 m/s, especially in the range from 0.1 to 20 m/s and more preferably in the range from 1 to 10 m/s. In the case of ultrasound liquefaction, this rate can quite possibly reach ranges of the speed of sound. The time over which shearing is effected, depending on the shear rate in a continuous process, may preferably be in the range from 0.01 to 90 min, more preferably in the range from 0.1 to 30 min.

To solidify the aqueous SiO₂ composition, it can preferably be left to stand for at least 0.1 minute, preferably at least 2 minutes, especially 20 minutes and more preferably at least 1 hour. The expression “leaving to stand” in this context means preferably that the composition is not exposed to any shear forces. In addition, solidification can be effected or accelerated, for example, by energy input, preferably heating, or additive addition. Additives here may be all crosslinkers familiar to those skilled in the art, for example silanes, especially functional silanes and here, without restricting the invention, for example, TEOS (Si(OC₂H₅)₄; tetraethoxysilane), which is advantageously available inexpensively in ultrahigh purity. Additives may also be substances which bring about a rise in the pH, for example to values which are preferably in the range from 2.5 to 6.5, more preferably from 2.5 to 4, for example alkaline compounds, and it may be preferable to use aqueous ammonia, which is preferably added after the mould casting.

In a preferred embodiment, solidification and/or drying of the aqueous SiO₂ composition is achieved by contacting it with a gaseous medium. The medium may especially be a hot gas and/or vapour, preferably steam or high-pressure steam. When the medium comprises a gas, this may consist of one or more chemical elements and/or one or more chemical compounds. The solidification and/or drying is especially accomplished by contacting the aqueous SiO₂ composition with the gaseous medium while the former is in a mould in any configuration, preferably comprising a sieve structure. This contacting is preferably effected by contacting the aqueous SiO₂ composition with the gaseous medium, which can be undertaken under standard pressure, but is especially undertaken under a pressure of up to 100 bar. In a particularly preferred embodiment, the gaseous medium contacted under pressure flows through the aqueous SiO₂ composition and, at least temporarily and at least in some regions, the sieve structure of the mould. By virtue of this procedure which is preferably effected using optionally superheated steam, it is possible to dewater the aqueous SiO₂ composition and thus to solidify it in the course of shaping.

Since the process enables compaction of the aqueous SiO₂ composition by approx. 60% by volume, it is particularly suitable for SiO₂-containing compositions with high water content. It is therefore possible with the process to directly process SiO₂-containing compositions which have been obtained from the precipitation process, i.e. without any need to dewater or dry them beforehand.

The mould of any configuration, preferably comprising a sieve structure, in which the aqueous SiO₂ composition is preferably present during the solidification and/or drying can—like any other part of the apparatus used to perform the process too—be coated with functional materials. Such a coating may be a chemically homogeneous or a composite material formed essentially from silicon and/or from oxygen, hydrogen, nitrogen, carbon, sulphur and/or from further elements of the Periodic Table of the Elements (PTE). Preference is given to using coatings whose chemical composition corresponds to or approaches that of the substances which are added to the aqueous SiO₂ composition in the course of processing.

The configuration of the mould, which preferably comprises a sieve structure, is as desired. In this context, reference is made to the disclosure of the document US 2006/0218970 and the geometries shown therein. Advantageous moulds for the drying process, which are accordingly preferred, are those which enable the production of mouldings with low wall thicknesses, since the water contents thereof can be removed with much shorter process times.

The sieve structure preferably included in the mould can be configured with conical, internal boundaries, which allows, for example, cylindrical tube pieces up to and including what are called doughnut shapes to be produced without any problem. Useful structures for performance of the process according to the invention have been found especially to be sieve structures manufactured from perforated masks from television technology or cathode ray tube technology, since these can be used as maintenance-free sieves. The characteristic features of such perforated masks are firstly a microscale orifice and secondly the configuration of the perforation on the low-pressure side, which has a conical or pyramidal geometry.

A preferred solidified aqueous SiO₂ composition may have a water content in the range from 2 to 98% by weight, especially 20 to 85% by weight, preferably 30 to 75% by weight and more preferably 40 to 65% by weight. The water content of a free-flowing SiO₂ composition may be within the same ranges.

In a particular configuration, an SiO₂ composition with a relatively low water content can be mixed with an SiO₂ composition having a higher water content in order to achieve the water content detailed above. The SiO₂ compositions used for this purpose need not necessarily be self-assembly compositions, but they may individually have this property.

In addition, a solidified aqueous SiO₂ composition is preferably notable for a pH of less than 5.0, preferably less than 4.0, especially less than 3.5, preferably less than 3.0, more preferably less than 2.5.

Surprising advantages can be achieved especially by a solidified aqueous SiO₂ composition with a pH greater than 0, preferably greater than 0.5 and more preferably greater than 1.0. The pH of the solidified aqueous SiO₂ composition can be determined by liquefying the latter using the free-flowing SiO₂ composition thus obtained. It is possible here to use customary measurement processes, for example those suitable for determining the H⁺ ion concentration.

The self-assembly SiO₂ compositions suitable for performance of the present invention may, in a preferred aspect, have a very high purity.

A preferred pure silicon dioxide features a content, measured by means of IPC-MS and sample preparation known to those skilled in the art:
a. aluminium less than or equal to 10 ppm or preferably between 5 ppm and 0.0001 ppm;
b. boron less than 10 ppm to 0.0001 ppm;
c. calcium less than 2 ppm, preferably between 2 ppm and 0.0001 ppm;
d. iron less than or equal to 20 ppm, preferably between 10 ppm and 0.0001 ppm;
e. nickel less than or equal to 10 ppm, preferably between 5 ppm and 0.0001 ppm;
f. phosphorus less than 10 ppm to 0.0001 ppm;
g. titanium less than or equal to 10 ppm, preferably less than or equal to 1 ppm to 0.0001 ppm;
h. zinc less than or equal to 3 ppm, preferably less than or equal to 1 ppm to 0.0001 ppm;
i. tin less than or equal to 10 ppm, preferably less than or equal to 3 ppm to 0.0001 ppm.

A preferred high-purity silicon dioxide features a sum total of the abovementioned impurities (a-i) of less than 1000 ppm, preferably less than 100 ppm, more preferably less than 10 ppm, even more preferably less than 5 ppm, especially preferably between 0.5 and 3 ppm and very especially preferably between 1 and 3 ppm, and a purity in the region of the detection limit may be the aim for each element, especially the metal elements. The figures in ppm are based on weight.

The determination of impurities is performed by means of ICP-MS/OES (inductively coupled spectrometry—mass spectrometry/optical electron spectrometry) and AAS (atomic absorption spectroscopy).

An aqueous SiO₂ composition usable in accordance with the invention can be obtained, for example, from a silicate-containing solution, for example a waterglass, by a precipitation reaction.

A preferred precipitation of a silicon oxide dissolved in aqueous phase, especially fully dissolved silicon oxide, is preferably performed with an acidifier. After reaction of the silicon oxide dissolved in aqueous phase with the acidifier, preferably by adding the silicon oxide dissolved in aqueous phase to the acidifier, a precipitate suspension is obtained.

An important process feature is the control of the pH of the silicon dioxide and of the reaction media in which the silicon dioxide is present during the different process steps for silicon dioxide preparation.

In this preferred aspect, the initial charge and the precipitate suspension to which the silicon oxide dissolved in aqueous phase, especially the waterglass, is added, preferably dropwise, must always be acidic. An acidic pH is understood to mean one below 6.5, especially below 5.0, preferably below 3.5, more preferably below 2.5, and in accordance with the invention below 2.0 to below 0.5. The aim may be control of the pH in the respect that the pH does not vary too greatly to obtain reproducible precipitation suspensions. If a constant or substantially constant pH is the aim, the pH should exhibit only a range of variation of plus/minus 1.0, especially of plus/minus 0.5, preferably of plus/minus 0.2.

In an especially preferred embodiment of the present invention, the pH of the initial charge and of the precipitate suspension is always kept less than 2, preferably less than 1, more preferably less than 0.5. It is additionally preferred when the acid is always present in a distinct excess relative to the alkali metal silicate solution in order to enable a pH less than 2 in the precipitate suspension at all times.

Without being bound to a particular theory, it can be assumed that a very low pH ensures that virtually no free negatively charged SiO groups to which troublesome metal ions can be bound are present on the silicon dioxide surface.

At very low pH, the surface is surprisingly actually positively charged, and so metal cations are repelled by the silica surface. If these metal ions are then washed out, provided that the pH is very low, it is thus possible to prevent them from becoming attached to the surface of the inventive silicon dioxide. If the silica surface takes on a positive charge, silica particles are additionally prevented from becoming attached to one another and thus forming cavities or gaps in which impurities could accumulate.

Particular preference is given to a precipitation process for producing purified silicon oxide, especially high-purity silicon dioxide, comprising the following steps:
preparing an initial charge from an acidifier with a pH of less than 2, preferably less than 1.5, more preferably less than 1, most preferably less than 0.5;
providing a silicate solution, it being especially advantageous to set the viscosity within particular viscosity ranges for production of the silicon oxide purified by precipitation, preference being given especially to a viscosity of 0.001 to 1000 Pas, it being possible according to the process regime to widen this viscosity range further—as detailed hereinafter—by virtue of further process parameters;
adding the silicate solution from step b. to the initial charge from step a. in such a way that the pH of the resulting precipitate suspension always remains at a value less than 2, preferably less than 1.5, more preferably less than 1 and most preferably less than 0.5; and
removing and washing the silicon dioxide obtained, the wash medium having a pH less than 2, preferably less than 1.5, more preferably less than 1 and most preferably less than 0.5.

According to the pH of the wash medium used, the SiO₂ composition can be washed with water to a higher pH. In this case, the SiO₂ composition can also be washed to pH values above the values given above and then lowered by adding acid. Accordingly, the silicon dioxide obtained can preferably be washed with water, which reduces the pH of the SiO₂ composition obtained preferably to a value in the range from 0 to 7.5 and/or the conductivity of the wash suspension to a value less than or equal to 100 μS/cm, preferably less than or equal 10 μS/cm and more preferably less than or equal to 5 μS/cm.

In a first particularly preferred variant of this process, preference is given to a precipitation process for production of purified silicon oxide, especially high-purity silicon dioxide, which is performed with silicate solutions of low to moderate viscosity, such that step b. can be amended as follows:
providing a silicate solution with a viscosity of 0.001 to 0.2 Pas.

In a second particularly preferred variant of this process, preference may be given to a precipitation process for production of purified silicon oxide, especially high-purity silicon dioxide, which is performed with silicate solutions of high or very high viscosity, such that step b. can be amended as follows:
providing a silicate solution with a viscosity of 0.2 to 10000 Pas.

In the different variants of the process detailed above, in step a., an initial charge is prepared from an acidifier or an acidifier and water in the precipitation vessel. The water is preferably distilled or demineralized water.

In all variants of the present process, not just in the particularly preferred embodiments described in detail above, the acidifiers used may be organic or inorganic acids, preferably mineral acids, more preferably hydrochloric acid, phosphoric acid, nitric acid, sulphuric acid, chlorosulphonic acid, sulphuryl chloride, perchloric acid, formic acid and/or acetic acid in concentrated or dilute form, or mixtures of the aforementioned acids. Particular preference is given to the aforementioned inorganic acids. Very particular preference is given to using hydrochloric acid, preferably 2 to 14 N, more preferably 2 to 12 N, even more preferably 2 to 10 N, especially preferably 2 to 7 N and very especially preferably 3 to 6 N, phosphoric acid, preferably 2 to 59 N, more preferably 2 to 50 N, even more preferably 3 to 40 N, especially preferably 3 to 30 N and very especially preferably 4 to 20 N, nitric acid, preferably 1 to 24 N, more preferably 1 to 20 N, even more preferably 1 to 15 N, especially preferably 2 to 10 N, sulphuric acid, preferably 1 to 37 N, more preferably 1 to 30 N, even more preferably 2 to 20 N, especially preferably 2 to 10 N. Very particular preference is given to using concentrated sulphuric acid.

The acidifiers can be used in a purity which is typically referred to as “technical grade”. It will be clear to the person skilled in the art that the diluted or undiluted acidifiers or mixtures of acidifiers used should entrain a minimum level of impurities which do not remain dissolved in the aqueous phase of the precipitate suspension into the process. In any case, the acidifiers should not have any impurities which would precipitate with the silicon oxide in the course of acidic precipitation, unless they could be held in the precipitate suspension by means of added complexing agents or by controlling the pH, or washed out with the later washing media.

The acidifier which has been used for precipitation may be the same which is used, for example, also in step d. to wash the filtercake.

In a preferred variant of this process, in step a., not only the acidifier but also a peroxide, which causes a yellow/orange colour with titanium(IV) ions under acidic conditions is added to the initial charge. This is more preferably hydrogen peroxide or potassium peroxodisulphate. The yellow/orange colour of the reaction solution allows very good appreciation of the degree of purification during wash step d.

This is because it has been found that specifically titanium constitutes a very persistent impurity which readily becomes attached to the silicon dioxide at pH values above 2. It has been found that, when the yellow colour disappears in stage d., the desired purity of the purified silicon oxide, especially of the silicon dioxide, has generally been attained, and the silicon dioxide can be washed from this time with distilled or demineralized water until a neutral pH of the silicon dioxide has been attained. In order to achieve this indicator function of the peroxide, it is also possible to add the peroxide not in step a. but rather in step b. to the waterglass, or in step c. as a third stream. In principle, it is also possible to add the peroxide only after step c and before step d. or during step d.

Preference is given especially to the variants in which the peroxide is added in step a. or b., since it can fulfil a further function in addition to the indicator function in this case. Without being bound to a particular theory, it can be assumed that some impurities—especially those containing carbon—can be oxidized by reaction with the peroxide and removed from the reaction solution. Other impurities are converted by oxidation to a form which has better solubility and can thus be washed out. The precipitation process according to the invention thus has the advantage that there is no need to perform a calcination step, although this is of course possible as an option.

In all variants of the process according to the invention, the silicon oxide dissolved in aqueous phase is preferably an aqueous silicate solution, more preferably an alkali metal and/or alkaline earth metal silicate solution, most preferably a waterglass. Such solutions can be purchased commercially, produced by liquefying solid silicates, produced from silicon dioxide and sodium carbonate, or produced, for example, directly from silicon dioxide and sodium hydroxide and water at elevated temperature via the hydrothermal process. The hydrothermal process may be preferred over the soda process because it can lead to cleaner precipitated silicon dioxides. One disadvantage of the hydrothermal process is the limited range of moduli obtainable; for example, the modulus of SiO₂ to Na₂O is up to 2, preferred modules being 3 to 4; in addition, the waterglasses after the hydrothermal process generally have to be concentrated before a precipitation. Generally, the person skilled in the art is aware of the production of waterglass as such.

In one alternative, an alkali metal waterglass, especially sodium waterglass or potassium waterglass, is optionally filtered and then, if necessary, concentrated. The filtration of the waterglass or of the aqueous solution of dissolved silicates to remove solid undissolved constituents can be effected by processes known per se to those skilled in the art and with apparatus known to those skilled in the art.

The silicate solution used preferably has a modulus, i.e. weight ratio of metal oxide to silicon dioxide, of 1.5 to 4.5, preferably 1.7 to 4.2, more preferably 2 to 4.0.

The precipitation process to produce an SiO₂ composition usable in accordance with the invention does not require the use of chelating reagents or of ion exchanger columns. It is also possible to dispense with calcination steps to calcine the purified silicon oxide. Thus, the present precipitation process is much simpler and less expensive than prior art processes. A further advantage of the precipitation process according to the invention is that it can be performed in conventional apparatus.

The use of ion exchangers for purification of silicate solutions and/or acidifiers before the precipitation is not obligatory but may be found to be appropriate according to the quality of the aqueous silicate solutions. Therefore, an alkaline silicate solution can also be pretreated according to WO 2007/106860 in order to minimize the boron and/or phosphorus content in advance. For this purpose, the alkali metal silicate solution (aqueous phase in which silicon oxide is dissolved) can be treated with a transition metal, calcium or magnesium, a molybdenum salt, or an ion exchanger modified with molybdate salts, to minimize the phosphorus content. Before the precipitation, in accordance with the process of WO 2007/106860, the alkali metal silicate solution can be supplied to the inventive precipitation under acidic conditions, especially at a pH less than 2. Preferably, however, acidifiers and silicate solutions which have not been treated by means of ion exchangers before the precipitation are used in the process according to the invention.

In a specific embodiment, a silicate solution, according to the processes of EP 0 504 467 B1, can be pretreated as a silica sol before the actual acidic inventive precipitation. For this purpose, the entire disclosure-content of EP 0 504 467 B1 is explicitly incorporated into the present document. The silica sol obtainable by the process disclosed in EP 0 504 467 B1 is preferably, after a treatment in accordance with the processes of EP 0 504 467 B1, fully dissolved again and then supplied to an inventive acidic precipitation in order to obtain purified silicon oxide in accordance with the invention.

The silicate solution preferably has, before the acidic precipitation, a silicon dioxide content of about at least 10% by weight or higher.

Preferably, a silicate solution, especially a sodium waterglass, used for acidic precipitation may have a viscosity of 0.001 to 1000 Pas, preferably 0.002 to 500 Pas, particularly 0.01 to 300 Pas, especially preferably 0.04 to 100 Pas (at room temperature, 20° C.). The viscosity of the silicate solution can preferably be measured at a shear rate of 10 1/s, the temperature preferably being 20° C.

In step b. and/or c. of the first preferred variant of the precipitation process, a silicate solution with a viscosity of 0.001 to 0.2 Pas, preferably 0.002 to 0.19 Pas, particularly 0.01 to 0.18 Pas and especially preferably 0.04 to 0.16 Pas and very especially preferably 0.05 to 0.15 Pas is provided. The viscosity of the silicate solution can preferably be measured at a shear rate of 10 1/s, the temperature preferably being 20° C. It is also possible to use mixtures of several silicate solutions.

In step b. and/or c. of the second preferred variant of the precipitation process, a silicate solution with a viscosity of 0.2 to 1000 Pas, preferably 0.3 to 700 Pas, particularly 0.4 to 600 Pas, especially preferably 0.4 to 100 Pas, very especially preferably 0.4 to 10 Pas and more particularly preferably 0.5 to 5 Pas is provided. The viscosity of the silicate solution can preferably be measured at a shear rate of 10 1/s, the temperature preferably being 20° C.

In step c. of the main aspect and of the two preferred variants of the precipitation process, the silicate solution from step b. is added to the initial charge and hence the silicon dioxide is precipitated. It should be ensured here that the acidifier is always present in excess. The silicate solution is added in such a way that the pH of the reaction solution is always less than 2, preferably less than 1.5, more preferably less than 1, even more preferably less than 0.5 and especially preferably 0.01 to 0.5. If necessary, further acidifier can be added. The temperature of the reaction solution is held during the addition of the silicate solution, by heating or cooling the precipitation vessel, at 20 to 95° C., preferably 30 to 90° C., more preferably 40 to 80° C.

Precipitates of particularly good filterability are obtained when the silicate solution enters the initial charge and/or precipitate suspension in droplet form. In a preferred embodiment, care is therefore taken that the silicate solution enters the initial charge and/or precipitate suspension in droplet form. This can be achieved, for example, by introducing the silicate solution into the initial charge by dropwise addition. This may involve metering equipment outside the initial charge/precipitate suspension and/or immersed into the initial charge/precipitate suspension.

In the first particularly preferred variant, i.e. the process with low-viscosity waterglass, it has been found to be particularly advantageous when the initial charge/precipitate suspension is set in motion, for example by stirring or pumped circulation, such that the flow rate measured in a region delimited by half the radius of the precipitation vessel±5 cm and the surface of the reaction solution down to 10 cm below the reaction surface is from 0.001 to 10 m/s, preferably 0.005 to 8 m/s, more preferably 0.01 to 5 m/s, very particularly 0.01 to 4 m/s, especially preferably 0.01 to 2 m/s and very especially preferably 0.01 to 1 m/s.

Without being bound to a particular theory, it can be assumed that, by virtue of the low flow rate, the entering silicate solution is distributed only to a minor degree immediately after entering the initial charge/precipitate suspension. This results in rapid gelation at the outer shell of the entering silicate solution droplets or silicate solution streams, before impurities can be enclosed in the interior of the particles. Optimal selection of the flow rate of the initial charge/suspension thus allows the purity of the product obtained to be improved.

By combining an optimized flow rate with introduction of the silicate solution very substantially in droplet form, this effect can be enhanced once again, and so an embodiment of the precipitation process in which the silicate solution is introduced in droplet form into an initial charge/precipitate suspension at a flow rate, measured in a region d delimited by half the radius of the precipitation vessel±5 cm and the surface of the reaction solution down to 10 cm below the reaction surface of 0.001 to 10 m/s, preferably 0.005 to 8 m/s, more preferably 0.01 to 5 m/s, very particularly 0.01 to 4 m/s, especially preferably 0.01 to 2 m/s and very especially preferably 0.01 to 1 m/s. In this way, it is also possible to obtain silicon dioxide particles which have very good filterability. In contrast, in processes in which a high flow rate is present in the initial charge/precipitate suspension, very fine particles are formed; these particles have very poor filterability.

In the second preferred embodiment of the precipitation process, i.e. in the case of use of high-viscosity waterglass, the result of dropwise addition of the silicate solution is likewise particularly pure precipitates with good filterability. Without being bound to a particular theory, it can be assumed that the high viscosity of the silicate solution together with the pH results in a precipitate with good filterability after step c., and that only a very low level of impurities, if any, is incorporated in inner cavities of the silicon dioxide particles, since the high viscosity substantially preserves the droplet form of the silicate solution added dropwise and the droplet is not finely distributed before the gelation/crystallization commences at the surface of the droplet. The silicate solutions used may preferably be the alkali metal and/or alkaline earth metal silicate solutions defined in detail above, preference being given to using an alkali metal silicate solution, particular preference to using sodium silicate (waterglass) and/or potassium silicate solution. It is also possible to use mixtures of two or more silicate solutions. Alkali metal silicate solutions have the advantage that the alkali metal ions can be removed easily by washing them out. The viscosity can be adjusted, for example, by concentrating commercial silicate solutions or by dissolving the silicates in water.

As explained above, suitable selection of the viscosity of the silicate solution and/or of the stirrer speed allows the filterability of the particles to be improved since particles with a specific shape are obtained. Preference is therefore given to purified silicon oxide particles, especially silicon dioxide particles which preferably have an external diameter of 0.1 to 10 mm, more preferably 0.3 to 9 mm and most preferably 2 to 8 mm. In a first specific embodiment of the present invention, these silicon dioxide particles have a ring shape, i.e. have a “hole” in the middle and are thus comparable in terms of shape to a miniature torus, also referred to herein as “donut”. The ring-shaped particles may assume a substantially round shape, or else a more oval shape.

In a second specific embodiment of the present precipitation process, these silicon dioxide particles have a shape comparable to a “mushroom head” or a “jellyfish”. In other words, instead of the hole of the above-described “donut”-shaped particles, in the middle of the ring-shaped base structure is a layer of silicon dioxide which is preferably thin, i.e. thinner than the ring-shaped part, is curved on one side and spans the inner opening of the “ring”. If these particles were to be placed on the ground with the curved side downward and viewed vertically from above, the particles would correspond to a dish with a curved base, a more solid, i.e. thick, upper edge and a somewhat thinner base in the region of the curve.

Without being bound to a particular theory, it can be assumed that the acidic conditions in the initial charge/reaction solution together with the dropwise addition of the silicate solution lead not only to the viscosity and the flow rate of the initial charge/precipitate suspension, but also to immediate commencement of gelation/precipitation at the surface of the droplet of the silicate solution on contact with the acid, and at the same time to deformation of the droplet as a result of the movement of the droplet in the reaction solution/initial charge. According to the reaction conditions, the “mushroom head”-shaped particles apparently form in the case of the slower droplet movement; in the case of faster droplet movements, in contrast, the “donut”-shaped particles are formed.

The silicon dioxide obtained after the precipitation is removed from the remaining constituents of the precipitate suspension. According to the filterability of the precipitate, this can be accomplished by conventional filtration techniques known to those skilled in the art, for example filter presses or rotary filters. In the case of precipitates of poor filterability, the removal can also be accomplished by means of centrifugation and/or by decanting off liquid constituents of the precipitate suspension.

After the removal from the supernatant, the precipitate is washed, and it should be ensured by means of a suitable wash medium that the pH of the wash medium during the washing and hence also of the purified silicon oxide, especially of the silicon dioxide, is less than 2, preferably less than 1.5, more preferably less than 1, even more preferably 0.5 and especially preferably 0.01 to 0.5.

The wash medium may preferably comprise aqueous solutions of organic and/or inorganic water-soluble acids, for example the aforementioned acids, or fumaric acid, oxalic acid, formic acid, acetic acid or other organic acids known to those skilled in the art, which themselves do not contribute to contamination of the purified silicon oxide if they cannot be removed completely with high-purity water. Generally, therefore, preference is given to all organic water-soluble acids, especially consisting of the elements C, H and O, both as acidifier and as wash medium, because they do not themselves contribute to contamination of the subsequent reduction step. Preferably, the acidifier used in steps a. and c., or mixtures thereof, is used in diluted or undiluted form.

The wash medium may, if required, also comprise a mixture of water and organic solvents. Appropriate solvents are high-purity alcohols such as methanol or ethanol. Any possible esterification does not disrupt the subsequent reduction to silicon.

The aqueous phase preferably does not contain any organic solvents such as alcohols and/or any organic polymeric substances.

In the process according to the invention, it is typically not obligatory to add chelating agents to the precipitate suspension or during the purification. Nevertheless, the present invention also encompasses processes in which a metal complexing agent such as EDTA is added to the precipitate suspension or else to a wash medium for stabilization of acid-soluble metal complexes. It is therefore optionally possible to add a chelating reagent to the wash medium or to stir the precipitated silicon dioxide in a wash medium with a corresponding pH of less than 2, preferably less than 1.5, more preferably less than 1, even more preferably 0.5 and especially preferably 0.01 to 0.5, comprising a chelating reagent. However, the wash with the acidic wash medium preferably immediately follows the removal of the silicon dioxide precipitate without performance of any further steps.

It is also possible to add a peroxide for colour labelling, as an “indicator” of unwanted metal impurities. For example, hydroperoxide can be added to the precipitate suspension or the wash medium in order to identify titanium impurities present by colour. Labelling is generally also possible with other organic complexing agents which in turn are not troublesome in the subsequent reduction process. These are generally all complexing agents based on the elements C, H and O; the element N may appropriately also be present in the complexing agent, for example for formation of silicon nitride, which advantageously decomposes again later in the process.

Washing is continued until the silicon dioxide has the desired purity. This can be recognized, for example, by the fact that the wash suspension contains a peroxide and visually no longer exhibits any yellow colouring. If the precipitation process according to the invention is performed without addition of a peroxide which forms a yellow/orange compound with Ti(IV) ions, a small sample of the wash suspension can be taken in each wash step and admixed with an appropriate peroxide. This operation is continued until the sample taken visually no longer exhibits a yellow/orange colour after addition of the peroxide. In this case, it should be ensured that the pH of the wash medium and hence also that of the purified silicon oxide, especially of the silicon dioxide, up to this time is less than 2, preferably less than 1.5, more preferably less than 1, even more preferably 0.5 and especially preferably 0.01 to 0.5.

The silicon dioxide washed and purified in this way is preferably washed further with distilled water or demineralized water until the pH of the silicon dioxide obtained is within a range from 0 to 7.5 and/or the conductivity of the wash suspension is less than or equal to 100 μS/cm, preferably less than or equal to 10 μS/cm and more preferably less than or equal to 5 μS/cm. The pH here may more preferably be within the range from 0 to 4.0, preferably 0.2 to 3.5, especially from 0.5 to 3.0 and more preferably 1.0 to 2.5. It is also possible here to use a wash medium containing an organic acid. This can ensure that any troublesome acid residues adhering to the silicon dioxide are removed to a sufficient degree.

The removal can be effected by customary measures sufficiently well-known to those skilled in the art, such as filtering, decanting, centrifuging and/or sedimentation, with the proviso that these measures do not worsen the degree of contamination of the acid-precipitated, purified silicon oxide again.

In the case of precipitates of poor filterability, it may be advantageous to perform the washing by flow of the wash medium onto the precipitate from below in a close-mesh sieve basket.

The purified silicon dioxide thus obtained, especially high-purity silicon dioxide, can be dried and processed further in order to adjust the self-assembly SiO₂ composition to the preferred proportions of water detailed hereinafter. The drying can be effected by means of all processes and apparatus known to those skilled in the art, for example belt driers, staged driers, drum driers, etc.

It is also possible in accordance with the invention to subject the SiO₂ composition directly—without preceding drying—to the further process for solidification and shaping.

It is surprisingly possible, by virtue of the process according to the invention, to obtain an SiO₂ moulding in any shape in a particularly simple and economically viable manner. For this purpose, it is possible to pour a free-flowing aqueous SiO₂ composition with the features specified in Claim 1 into a mould.

In this case, the free-flowing aqueous SiO₂ composition can be introduced into a mould with the desired dimensions and distributed in any desired manner. For example, the introduction can be effected by hand or by machine using distributor units. The filled mould can be subjected to vibration in order to achieve rapid and homogeneous distribution of the aqueous SiO₂ composition in the mould.

To produce SiO₂ mouldings which can be contacted with carbon compounds in order to obtain metallic silicon therefrom, it is possible, for example, to cast a pellet shape in sizes suitable for use in a light arc furnace. These pellets preferably do not have any corners and edges, in order to minimize abrasion. Suitable pellets may have, inter alia, a cylinder shape with rounded corners, which more preferably have a diameter in the range from 25 to 80 mm, even more preferably 35 to 60 mm, with a length to diameter (L/D) ratio of preferably 0.01 to 100, especially 0.1 to 2 and more preferably 0.5 to 1.2. In addition, preferred pellets may be present in the form of frustocones with rounded edges or hemispheres. The size of the SiO₂ mouldings is preferably in the range from 0.001 to 100000 cm³, especially 0.01 to 10000 cm³, more preferably 0.1 to 1000 cm³, especially preferably 1 to 100 cm³, especially for a 500 kW furnace. The size depends directly on the process regime. The moulds can be adapted according to process and technical aspects, for example in the form of a gravel or grit, preference being given to a grit briquette in the case of supply through a tube. Gravel may be advantageous in the case of direct addition.

The casting moulds for use to produce the mouldings are not subject to any particular requirements, although the use thereof should not let any impurities into the SiO₂ mouldings. For example, suitable casting moulds can be produced from high-temperature-resistant, pure polymers (silicone, PTFE, POM, PEEK), ceramic (SiC, Si₃N₄), graphite in all its forms, metal with suitable high-purity coating and/or quartz glass. In a particularly preferred embodiment, the moulds are segmented, which allows particularly simple demoulding. In a particular embodiment, the mould to be filled with the aqueous SiO₂ composition comprises a sieve structure through which gaseous media can flow.

After the moulding, the solidified aqueous SiO₂ composition is stabilized by means of an alkaline additive and/or by drying. For this purpose, the filled casting mould, without or with additive addition, can be transferred into a drier which is heated, for example, electrically, with hot air, steam, IR rays, microwaves or combinations of these heating methods. It is possible here to use customary apparatus, for example belt driers, staged driers, drum driers, which dry continuously or batchwise.

Advantageously, the SiO₂ mouldings can be dried to a water content which enables nondestructive demoulding from the casting moulds. Accordingly, the drying in the casting mould can be performed down to a water content of less than 60% by weight, especially less than 50% by weight and more preferably less than 40% by weight.

Drying to a water content below the values mentioned can more preferably follow demoulding of the SiO₂ moulding, in which case the driers detailed above can be used.

Surprising advantages are exhibited, inter alia, by SiO₂ mouldings which, after drying, have a water content in the range from 0.0001 to 50% by weight, preferably 0.0005 to 50% by weight, especially 0.001 to 10% by weight and more preferably 0.005 to 5% by weight, measured by means of the thermogravimetry method known in general terms to those skilled in the art (IR moisture measuring instrument).

The solidified aqueous SiO₂ composition can preferably be dried at a temperature in the range from 50° C. to 350° C., preferably 80 to 300° C., especially 90 to 250° C. and more preferably 100 to 200° C. under standard conditions (i.e. at standard pressure).

The pressure at which the drying is effected may be within a wide range, and so the drying can be performed under reduced or elevated pressure. For economic reasons, preference may be given to drying at ambient or standard pressure (950 to 1050 mbar).

To increase the hardness of the dried SiO₂ moulding, it can be thermally consolidated or sintered. This can be executed, for example, batchwise in conventional industrial furnaces, for example shaft furnaces or microwave sintering furnaces, or continuously, for example in what are called pusher furnaces or shaft furnaces.

The thermal consolidation or sintering can be effected at a temperature in the range from 400 to 1700° C., especially 500 to 1500° C., preferably 600 to 1200° C. and more preferably 700 to 1100° C.

The duration of the thermal consolidation or sintering depends on the temperature, the desired density and, if appropriate, the desired hardness of the SiO₂ moulding. The thermal consolidation or sintering can preferably be performed over a period of 5 h, preferably 2 h, more preferably 1 h.

The dried and/or sintered SiO₂ mouldings with the above-described typical dimensions may have, for example, a compressive strength (reported as breaking force) of at least 10 N/cm², preferably of more than 20 N/cm², and particularly sintered SiO₂ mouldings may exhibit compressive strength values of at least 50 or even at least 150 N/cm², in each case measured by means of pressure tests on an arrangement for compressive strength testing.

The density of the SiO₂ moulding can be matched to the end use. In general, the SiO₂ moulding may have a density in the range from 0.6 to 2.5 g/cm³. In the case of high-temperature sintering, a density of 2.65 (quartz glass density) can even be achieved. In the case of an SiO₂ moulding for production of metallic silicon, in one possible embodiment, the aim is preferably an amorphous structure with a high internal surface area of the body, in order to ensure good and homogeneous contact of the carbon source introduced later, for example, with the silicon dioxide. In this aspect of the present invention, preferred SiO₂ mouldings have a density in the range from 0.7 to 2.65 g/cm³, especially 0.8 to 2.0 g/cm³, preferably 0.9 to 1.9 g/cm³ and more preferably 1.0 to 1.8 g/cm³. The density is based, as explained, on that of the moulding, and so the pore volume of the moulding is also included in the determination.

In addition, the specific surface area of preferred SiO₂ mouldings for production of metallic silicon may be in the range from 20 to 1000 m²/g, especially in the range from 50 to 800 m²/g, preferably in the range from 100 to 500 m²/g and more preferably in the range from 120 to 350 m²/g, measured by the BET method. The specific nitrogen surface area (referred to hereinafter as BET surface area) of the SiO₂ moulding is determined to ISO 9277 as the multipoint surface area. The measuring instrument used is the TriStar 3000 surface area measuring instrument from Micromeritics. The BET surface area is typically determined within a partial pressure range of 0.05-0.20 of the saturation vapour pressure of liquid nitrogen. The sample is prepared, for example, by heating the sample at 160° C. for one hour in reduced pressure in the VacPrep 061 degasser from Micromeritics.

In a further embodiment, the SiO₂ moulding may preferably have a higher density, preferably a density of at least 2.2 g/cm³, more preferably at least 2.4 g/cm³. This embodiment can be used, for example, for production of crucibles in which metallic silicon is purified by directional solidification.

The density and the specific surface area of the dried mouldings, for example of the pellets, can be controlled, inter alia, via the shear input, the pH, the temperature and/or the water content in the SiO₂ casting material. At comparable water content, it is possible, for example, also to increase the pellet density with an increase in the shear input. In addition, the density can be adjusted via the pH and the solids content of the SiO₂ composition, a decrease in the solids content being associated with a reduction in density. A further significant influence on density or porosity of the mouldings can be achieved in the subsequent sintering step. In this context, the maximum sintering temperature in particular is of significance, and also the hold time at this temperature. With rising sintering temperature and/or hold time, it is possible to achieve higher densities of the mouldings.

According to the end use, the SiO₂ moulding can be processed further. In a preferred embodiment, the SiO₂ moulding after sintering can be contacted with a carbon compound.

For this purpose, the pure carbon source used may be one or more pure carbon sources, optionally in a mixture, an organic compound of natural origin, a carbohydrate, graphite (activated carbon), coke, charcoal, soot, carbon black, thermal black, pyrolysed carbohydrate, especially pyrolysed sugar. The carbon sources, especially in pellet form, can be purified, for example, by treatment with hot hydrochloric acid solution. In addition, an activator can be added to the process according to the invention. The activator may fulfil the purpose of a reaction initiator, reaction accelerator, or else the purpose of the carbon source. An activator is pure silicon carbide, silicon-infiltrated silicon carbide, and pure silicon carbide with a carbon and/or silicon oxide matrix, for example silicon carbide comprising carbon fibres.

For loading, the SiO₂ moulding can be provided with the carbon compounds mentioned, preferably carbon black (technical carbon black; industrial carbon black), especially thermal black, lamp black or carbon black by the Kværner process known to the carbon black expert; and/or a carbohydrate, more preferably one or more mono- or disaccharides. These carbon compounds can be introduced via solutions and/or dispersions of these carbon compounds. Preferably, a porous SiO₂ moulding, which preferably has a density and/or specific surface area with the values given above, can be impregnated with an aqueous composition comprising at least one carbohydrate and/or carbon black. In order to improve the absorption of the composition into the porous body, it can be exposed beforehand to a reduced pressure or to a vacuum in order to remove the gas present in the pores. Subsequently, the SiO₂ moulding thus obtained, which has been provided with at least one carbon compound, can be brought to a temperature greater than 500° C. in order to pyrolyse the carbon compound.

In a further aspect of the present invention, preferred SiO₂ mouldings can be used for production of crucibles in which metallic silicon can be purified by directional solidification. These crucibles typically have a multilayer structure, the outermost layer ensuring mechanical stability. This layer may be formed, for example, from graphite. The further layer provides chemical separation between the metallic silicon and the supporting layer. This further layer is preferably formed by silicon dioxide, which can more preferably be provided with an Si₃N₄ layer.

The mouldings detailed above, which are obtainable by the process according to the invention, are novel and likewise form part of the subject-matter of the present invention.

The SiO₂ mouldings detailed above are preferably used in processes for producing metallic silicon, as can be used, for example, for production of solar cells.

The definitions of metallurgical and solar silicon are common knowledge. For instance, solar silicon has a silicon content of greater than or equal to 99.999% by weight.

The further steps and characteristics of processes for producing metallic silicon are detailed in WO 2010/037694 inter alia. In this process, SiO₂ is reduced by carbon in a light arc furnace to give metallic silicon. The starting material used is typically an SiO₂ moulding in combination with a carbon source. Accordingly, the publication WO 2010/037694, filed on 28 Sep. 2009 at the European Patent Office with Application Number PCT/EP2009/062387, is incorporated into the present application by reference for disclosure purposes.

The examples which follow illustrate the process according to the invention in detail without restricting the invention to these examples.

### PREPARATION EXAMPLE

A 4000 ml quartz glass round-bottom flask with a two-neck adaptor, bulb condenser, Liebig condenser (each made of borosilicate glass) and 500 ml measuring cylinder—to collect the distillate—was initially charged with 1808 g of waterglass (27.2% by weight of SiO₂ and 7.97% by weight of Na₂O) and 20.1 g of 50% sodium hydroxide solution. The sodium hydroxide solution was added in order to achieve an increased Na₂O content in the concentrated waterglass. The solution was blanketed with nitrogen in order to prevent reaction with carbon dioxide from the air and then heated to boiling by means of a heating mantel. Once 256 ml of water had been distilled off, the Liebig condenser was replaced by a stopper and the mixture was boiled under reflux for a further 100 min. Thereafter, the concentrated waterglass was cooled to room temperature under a nitrogen atmosphere and left to stand overnight. 1569 g of concentrated waterglass with a viscosity of 537 mPa*s (i.e. 5.37 poise) were obtained.

A 4000 ml quartz glass two-neck flask with precision glass stirrer and dropping funnel (each made of borosilicate glass) was initially charged with 2513 g of 16.3% sulphuric acid and 16.1 g of 35% hydrogen peroxide at room temperature. Within 3 min, 1000 ml of the concentrated water glass prepared beforehand (9.8% by weight of Na₂O, 30.9% by weight of SiO₂, density 1.429 g/ml) were then added dropwise such that the pH remained below 1. In the course of this, the reaction mixture heated up to 50° C. and turned deep orange. The suspension was stirred for a further 20 min and then the solids obtained were allowed to settle.

For workup, the supernatant solution was decanted off and a mixture of 500 ml of demineralized water and 50 ml of 96% sulphuric acid was added to the residue. While stirring, the suspension was heated to boiling, the solids were allowed to settle and the supernatant was decanted off again. This washing operation was repeated until the supernatant exhibited only quite a pale yellow colour. This was followed by repeated washing with 500 ml each time of demineralized water until a pH of the wash suspension of 5.5 had been attained. The conductivity of the wash suspension was now 3 μS/cm. The supernatant was decanted off and the product obtained was dried.

### EXAMPLES (INVENTIVE)

### Example 1

A batchwise mixing apparatus was initially charged with 4.6 kg of SiO₂ which had been prepared by the process described above and had a water content of approx. 61%, and the pH was adjusted to approx. 2.5 with sulphuric acid. The product was converted to a liquid state with a peripheral speed of the mixing tool of approx. 17 m/s. Subsequently, 0.5 kg of SiO₂ with a residual moisture content of approx. 3% was added in portions, in the course of which it was sheared intensively and liquefied. After the addition of the entire amount and a total shear time of 21 min, a homogeneous composition with good flowability and a water content of approx. 54% was obtained. The composition was poured onto a mould sheet and distributed homogeneously into the individual moulds. The individual moulds of the sheet were cylindrical with a diameter of D=40 mm and a depth of H=45 mm. The filled mould sheet was dried at T=105° C. in a forced air drying cabinet overnight. The dried mouldings were then tested in a compressive strength test, which determined a compressive strength of approx. 35 N/cm² at a breaking force of approx. 450 N. These values were typical averages. Some of the mouldings were sintered at 1000° C. over 8 hours and then the compressive strength was measured. A distinctly increased value of approx. 100 N/cm² at a breaking force of 1140 N was measured. The values may even be higher.

### Example 2

The composition which has good flowability and a water content of approx. 54% and was obtained in the preceding example was alternatively solidified and dried using an espresso machine with a single-screw extractor and 15 bar steam generator. For this purpose, the SiO₂/water mixture was introduced into the sieve pot of the single-screw extractor and contacted with 15 bar steam for approx. 20 seconds. In the course of this, the superheated steam vaporized the water present in the SiO₂-containing composition to a residual moisture content of approx. 25%. The extractor was removed again from the arrangement and exhibited a highly compacted filtercake, which was removable by “tapping out” as a dimensionally stable pellet without breaking up. Four pellets produced in this way were tested in the compressive strength test, and an average compressive strength of approx. 38 N/cm² and an average breaking force of approx. 455 N were determined.

It is advantageous, though very unusual, in the context of this process that the sieve pores of the extractor are not blocked in any way by residues of the SiO₂-containing composition, which possibly results from the self-assembly properties thereof.

### Example 3

A continuous colloid mill was filled with HP water (HP=High Purity) and the circulation in the system was built up by pumped circulation. The filling funnel was then used for stepwise metered addition of SiO₂ which had been prepared by the process described above and had a water content of approx. 59%. By regularly sampling material from the circuit and continuously charging further SiO₂, the water in the initial charge was displaced stepwise from the system until the target value for the solids concentration had been attained. In the steady state, solids were metered in at a rate of 60 kg/h and the SiO₂ composition was withdrawn at the same rate. The composition in the system was adjusted to a pH of approx. 2.8 by adding sulphuric acid. Under these conditions, a homogeneous SiO₂ composition with good flowability was obtained, and the composition was kept at a process temperature of 20° C. over the process duration.

The composition was poured onto a mould sheet and distributed homogeneously into the individual moulds. The individual moulds of the sheet were cylindrical with a diameter of D=40 mm and a depth of H=45 mm. The filled mould sheet was dried at T=105° C. in a forced air drying cabinet overnight. The dried mouldings were then tested in a compressive strength test, the result of which was 20 N/cm² at a breaking force of approx. 237 N. This value was a typical average. Some of the mouldings were sintered at 1000° C. over 8 hours and then the compressive strength was measured. An increased compressive strength of approx. 60 N/cm² was measured at a breaking force of greater than 730 N.

1. A process for producing SiO₂ mouldings, the process comprising: preparing a free-flowing aqueous SiO₂ composition; solidifying the free-flowing aqueous SiO₂ composition to form a solidified aqueous SiO₂ composition, and drying the solidified aqueous SiO₂ composition to form a dried SiO₂ moulding, wherein the aqueous SiO₂ composition is a self-assembly composition.

2. The process according to claim 1, wherein the aqueous SiO₂ composition is poured into a mould.

3. The process according to claim 2, wherein the mould has a sieve structure.

4. The process according to claim 1, wherein a gaseous medium is contacted with or flows through the free-flowing aqueous SiO₂ composition.

5. The process according to claim 4, wherein the gaseous medium is steam or high-pressure steam.

6. The process according to claim 1, wherein the solidified aqueous SiO₂ composition has a water content in the range from 2 to 98% by weight.

7. The process according to claim 1, wherein the free-flowing aqueous SiO₂ composition has a pH less than 3.5.

8. The process according to claim 1, wherein the solidified aqueous SiO₂ composition is rendered free-flowing for shaping by the action of shear forces.

9. The process according to claim 1, wherein solidifying comprises leaving the aqueous SiO₂ composition to stand for at least 0.1 minute.

10. The process according to claim 1, wherein an additive is added to the aqueous SiO₂ composition to effect or accelerate solidification.

11. The process according to claim 11, wherein the additive is a silane.

12. The process according to claim 1, wherein the free-flowing aqueous SiO₂ composition comprises an alkaline compound.

13. The process according to claim 1, wherein the free-flowing aqueous SiO₂ composition comprises an aqueous solution of a silicate added to an acid, the process further comprising washing the solidified aqueous SiO₂ composition with an acid.

14. The process according to claim 13, further comprising washing the solidified aqueous SiO₂ composition with water after washing with an acid.

15. The process according to claim 1, wherein drying is performed at a temperature in the range from 50° C. to 350° C.

16. The process according to claim 1, wherein the dried SiO₂ moulding has a water content in the range from 0.0001 to 50% by weight, measured by means of thermogravimetry.

17. The process according to claim 1, wherein drying is performed at a temperature in the range from 600 to 1200° C., the process further comprising sintering the dried SiO₂ moulding.

18. The process according to claim 1, wherein the dried SiO₂ moulding has a density in the range from 0.7 to 2.5 g/cm³.

19. The process according to claim 1, wherein the dried SiO₂ moulding has a density of at least 2.4 g/cm³.

20. The process according to claim 1, further comprising contacting the dried SiO₂ moulding with a carbon compound.

21. A moulding produced by the process according to claim 1.
